(19) United States
(12) Patent Application Publication
(10) Pub. No.: US 2011/0169390 A1
(43) Pub. Date: Jul. 14, 2011

(54) MAGNETRON, MAGNETRON CATHODE BODY MANUFACTURING METHOD, AND CATHODE BODY

(76) Inventors: Tadahiro Ohmi, Miyagi (JP); Tetsuya Goto, Miyagi (JP)

(21) Appl. No.: 13/063,583

(22) PCT Filed: Sep. 17, 2009
(86) PCT No.: PCT/JP2009/066220

§ 371 Date: Mar. 11, 2011

(30) Foreign Application Priority Data
Sep. 18, 2008 (JP) 2008-238887

(51) Int. Cl. H01J 7/26; H01J 1/14; H01J 1/00; H01J 9/04

(52) U.S. Cl. 313/35; 313/346 R; 313/326; 445/51

(57) ABSTRACT

It is an object of the present invention to obtain a cathode body capable of maintaining a long service life even when a high current flows therethrough. According to the present invention, it is possible to obtain a magnetron cathode body including, as a base material, a high-melting-point metal containing an electron emission material, and rare-earth boride coating a surface thereof. As the electron emission material and the high-melting-point metal, La₂O₃ and W are desirable, respectively. As the rare-earth boride, LaB₆ is preferable.

### TECHNICAL FIELD

This invention relates to a magnetron as a microwave oscillation device for use in a microwave oven and an industrial plasma generation apparatus and, in particular, to a magnetron improved in reliability and increased in service life.

### BACKGROUND ART

Referring to FIG. 1, a structure of a conventional magnetron is partially illustrated. 101 represents a cathode body, 102, anode vanes forming an anode, 103, a cooling water coil for cooling the anode, and 104, a current introducing terminal for heating the cathode body to emit thermal electrons from the cathode body. In general, the anode is grounded. On the other hand, the cathode body has a filament structure. The anode is supplied with a negative high DC voltage of about several kV to 10 kV. Further, a large AC current of about several 10 A to 100 A is supplied to the filament through an insulating transformer to heat the filament. Thus, thermal electrons are emitted.

Herein, a predetermined DC perpendicular magnetic field is applied to an interaction space 106 between the filament and the anode by an electromagnet 105. Therefore, in an electric field between the filament and the anode, the emitted electrons are accelerated in an anode direction and perform circling movement in the interaction space under the action of the Lorentz force due to the DC perpendicular magnetic field. The plural anode vanes are axisymmetrically disposed. A resonant frequency of a space formed by the anode vanes adjacent to each other is set at a frequency of microwave to be produced. When the stream of the circling electrons passes through the vicinity of end portions of the anode vanes, strong oscillation is caused to occur at the resonant frequency of the resonant cavity, that is, the frequency of the microwave to be produced. High-frequency power obtained by oscillation is outputted by a loop or a slit antenna to a waveguide or the like outside a tube bulb.

As a technique related to the above-mentioned magnetron, for example, there are techniques described in Patent Documents 1, 2, and 3 (Patent Documents 1, 2, and 3).

### PRIOR ART DOCUMENT(S)

### Patent Document(s)

Patent Document 1: JP-A-H11-283516
Patent Document 2: JP-A-2008-53129
Patent Document 3: JP-A-2003-100224

### SUMMARY OF THE INVENTION

### Problem to be Solved by the Invention

In the conventional technique mentioned above, the filament is generally formed of W with an electron emission material, such as ThO₂, contained therein. ThO₂ as the electron emission material has a relatively low work function, while W has a work function as high as 4.6 eV. Therefore, for the purpose of emitting a sufficient amount of electrons, the filament must reach a high temperature by heating or the like. Thus, there is a problem that a filament life is short because of troubles, such as evaporation and embrittlement of the heated filament.

Further, in order to sufficiently heat the filament, the supplied AC current must be very large. Particularly, as an industrial magnetron capable of producing a high power of several tens to 100 kW, a magnetron having an oscillation frequency of 915 MHz is used more often than a magnetron having an oscillation frequency of 2.45 GHz. Thus, the high-power magnetron of a 100 kW output, which is used as the industrial magnetron, requires an electric current as high as 100 A. When the high current of 100 A flows through the filament, various problems inherent to the high-power magnetron are caused to occur.

For example, voltage drop at the filament due to the high current is about 10V which is sufficiently small in comparison to a high voltage applied to the cathode for the purpose of generating an electric field. Therefore, an influence to the electric field applied between the anode and the filament is negligible. However, an AC magnetic field generated in the interaction space by such a high current flowing through the filament is not negligible, in comparison to the perpendicular magnetic field applied from the outside. Therefore, there is a problem that ripples are caused to occur in an output power and in an oscillation frequency. Furthermore, a cooling water tube for cooling the anode has an inner diameter of about 10 mm or less. In order to remove heat generated in the magnetron, water of a high flow rate of about 10 L/minute is typically required. Thus, a heavy load is imposed on a cooling water pump. When the water of a high flow rate flows through the tube having the inner diameter of about 10 mm or less, a flow velocity of the water is high and heat is not efficiently removed. Therefore, there is a problem that highly-controllable anode cooling is not possible.

Meanwhile, in an ordinary magnetron, it is known that, as an electron emission member for improving electron emission of a cathode, one or a plurality of materials other than ThO₂, for example, hafnium oxide, zirconium oxide, lanthanum oxide, cerium oxide, and the like are used in combination with tungsten, as disclosed in Patent Document 1 and so on. Even in such a case, an electron emission characteristic is insufficient. Particularly, in connection with the industrial magnetron required to have a high power of 100 kW, it has not been fully examined whether or not the above-mentioned electron emission members can maintain a sufficient service life.

Further, for the purpose of anode heat dissipation, there are known techniques of air-cooling by providing the anode with a number of fins and improving a liquid-cooling structure as disclosed in Patent Documents 2 and 3. However, in the industrial magnetron, sufficient cooling may not be possible. Therefore, it is an object of the present invention to provide a magnetron having an excellent electron emission characteristic over a longer time than ever.

It is another object of the present invention to provide a magnetron having a more efficient anode cooling structure than ever.

It is still another object of the present invention to provide a magnetron capable of preventing ripples in an output power and in an oscillation frequency.

### Means to Solve the Problem

The present inventors previously proposed, in Japanese Patent Application No. 2007-99778 and so on, a sputtering apparatus capable of preventing local wear of a target, increasing a plasma density, and improving a film forming rate by moving a ring-shaped plasma region on the target with time. The sputtering apparatus has a structure in which the target is disposed to face a substrate to be processed and which comprises a magnet member disposed opposite to the substrate to be processed with respect to the target.

In detail, the magnet member of the sputtering apparatus mentioned above comprises a rotary magnet group including a plurality of plate magnets spirally adhered to a surface of a rotary shaft and a fixed outer peripheral plate magnet which is arranged around the rotary magnet group in parallel with a target surface and which is magnetized in a direction perpendicular to the target. With this structure, by rotating the rotary magnet group, a magnetic field pattern formed on the target by the rotary magnet group and the fixed outer peripheral plate magnet is continuously moved in a direction of the rotary shaft. Consequently, the plasma region on the target can continuously be moved with time in the direction of the rotary shaft.

By using the rotary magnet spattering apparatus, it is possible to uniformly use the target for a long period of time and to improve a film-forming rate.

According to a first aspect of the present invention, there is provided a magnetron characterized by comprising a cathode body which includes, as a base material, a high-melting-point metal containing an electron emission material, and rare-earth boride with which a surface of the base material is coated.

According to a second aspect of the present invention, there is provided the magnetron characterized in that the electron emission material is La₂O₃ and the rare earth boride is LaB₆.

According to a third aspect of the present invention, there is provided a magnetron characterized by including, as a cathode body, an electrode comprising an electrode member containing tungsten or molybdenum as a main component and La₂O₃, and a film of rare-earth boride formed by sputtering on a surface of the electrode member.

According to a fourth aspect of the present invention, there is provided the magnetron according to the third aspect, characterized in that the rare-earth boride includes at least one boride selected from a group consisting of LaB₄, LaB₆, YbB₆, GaB₆, and CeB₆.

According to a fifth aspect of the present invention, there is provided the magnetron characterized in that the cathode body contains 4 to 6% La₂O₃ by volume ratio.

According to a sixth aspect of the present invention, there is provided a method of manufacturing a magnetron cathode body, characterized by comprising forming a LaB₆ film by sputtering using a plasma sputtering apparatus on a surface of a cathode body containing tungsten or molybdenum as a main component.

According to a seventh aspect of the present invention, there is provided the method of manufacturing a magnetron cathode body according to the sixth aspect, characterized by comprising the step of annealing, in an inactive gas atmosphere, the LaB₆ film formed by sputtering.

According to an eighth aspect of the present invention, there is provided the method of manufacturing a magnetron cathode body according to the seventh aspect, characterized in that an annealing temperature is between 400° C. and 1000° C. in the annealing step.

According to a ninth aspect of the present invention, there is provided the method of manufacturing a magnetron cathode body according to the sixth or the seventh aspect, characterized in that the LaB₆ film is formed by sputtering by RF-DC coupled discharge with a normalized ion irradiation amount of 5 to 17.

According to a tenth aspect of the present invention, there is provided The magnetron according to any one of the first to the fifth aspect, characterized in that a plurality of tubes for cooling water to flow therethrough are brought into contact with an anode in parallel to cool the anode.

According to an eleventh aspect of the present invention, there is provided the magnetron according to any one of the first to the fifth aspect, characterized by comprising a cylindrical jacket arranged outside of the anode and supplied with cooling water to flow therethrough so as to cool the anode.

According to a twelfth aspect of the present invention, there is provided the magnetron according to the tenth or the eleventh aspect, characterized in that, at a part of a flow path for the cooling water to pass therethrough, which part is brought into contact with the anode, the Reynolds number of the cooling water passing therethrough is set within a range between 1000 and 5000.

According to a thirteenth aspect of the present invention, there is provided the magnetron according to the twelfth aspect, characterized in that, in a cooling water tube for supplying the cooling water to the magnetron, the Reynolds number of the cooling water passing therethrough is set to 1000 or less.

According to a fourteenth aspect of the present invention, there is provided the magnetron according to any one of the first to the fifth and the tenth to the thirteenth aspect, characterized in that, in order to emit a thermal electron by heating the cathode body, the cathode body is heated by supplying a DC current.

### Effect of the Invention

According to the present invention, by using, as a base material, a high-melting-point metal with an electron emission material contained therein and coating a surface of the base material with rare-earth boride, it is possible to obtain a cathode body capable of maintaining a long service life even when a high current of 100 A flows therethrough.

### BRIEF DESCRIPTION OF THE DRAWING

FIG. 1 is a schematic view showing a part of a conventional magnetron.

FIG. 2 is a schematic view showing a filament portion according to a first embodiment of the present invention.

FIG. 3 is a graph for comparatively describing a thermal electron emission characteristic of ThO₂-containing W and a thermal electron emission characteristic of La₂O₃-containing W.

FIG. 4 is a schematic view for describing a magnetron according to a second embodiment of the present invention.

FIG. 5 is a schematic view for describing a magnetron according to a third embodiment of the present invention.

FIG. 6 is a schematic view for describing a magnetron according to a fourth embodiment of the present invention.

FIG. 7 is a schematic view showing a rotary magnet sputtering apparatus for use in manufacturing a magnetron cathode body according to the present invention.

FIG. 8 is a view showing pressure dependencies of a peak intensity and a sheet resistance of a (100) plane of a LaB₆ film when sputtering film formation is performed by DC discharge.

FIG. 9 is a view showing normalized ion irradiation amount dependencies of the peak intensity and the sheet resistance of the (100) plane of the LaB₆ film.

### DESCRIPTION OF REFERENCE NUMERALS

201 filament
203 lower end seal
204 center lead
205 side lead
206 upper end seal
207 getter material
208 brazing material
401 inlet tube
402 first cooling tube
403 second cooling tube
404 third cooling tube
405 outlet tube
406 magnetron
501 tube
502 tube
503 jacket
504 baffle plate
601 DC magnetic field
602 DC power source
603 DC magnetic field
604 filament
605 anode vane
606 interaction space
1 target
2 columnar rotary shaft
3 rotary magnet group
4 fixed outer peripheral magnet
5 outer peripheral paramagnet
6 backing plate
7 housing
8 refrigerant path
9 insulating material
11 space in processing room
12 feeder line
13 cover
14 outer wall
15 paramagnet
16 plasma shielding member
18 slit

### MODE FOR EMBODYING THE INVENTION

Hereinbelow, embodiments of the present invention will be described with reference to the drawing.

### First Embodiment

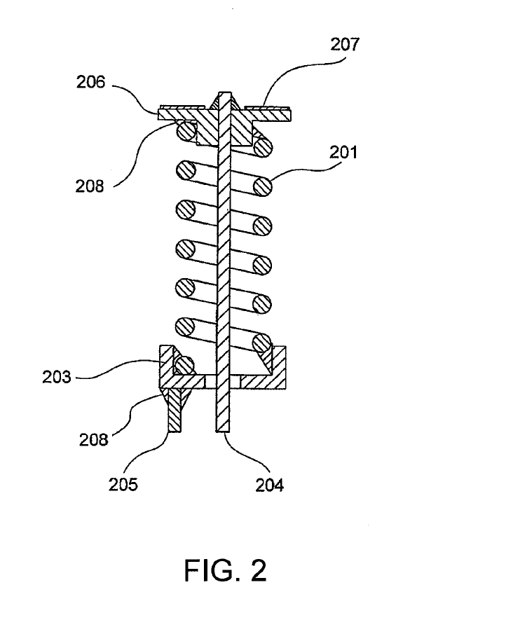

A first embodiment of the present invention will be described using FIG. 2. 201 represents a filament, 203, a lower end seal, 204, a center lead, 205, a side lead, 206, an upper end seal, 207, a getter material, and 208, a brazing material for connecting the end seals and the leads and connecting the end seals and the filament. The present inventors have found that, by using, as a base material of the filament, W with La₂O₃ introduced by 4 to 6%, preferably 2 to 3%, by volume ratio and forming a LaB₆ thin film of about 100 nm on a surface of the base material by magnetron sputtering, an emission current which is stable and sufficient for microwave oscillation could be obtained at a low temperature of about 1400° C., as compared to conventional ThO₂-containing W.

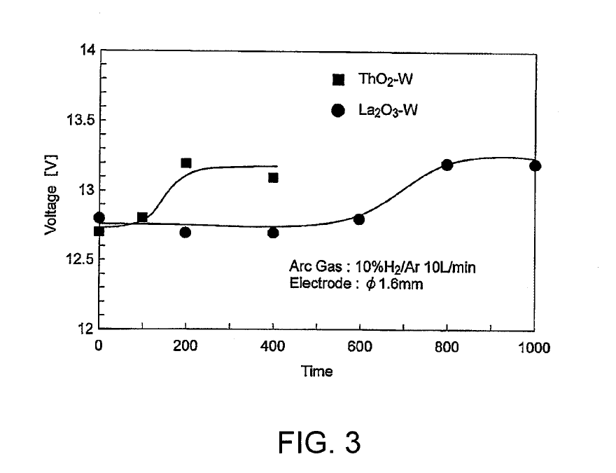

FIG. 3 shows thermal electron emission characteristics of ThO₂-containing W and La₂O₃-containing W, which are obtained as a result of processing each material into a discharge electrode having a diameter of 1.6 mm and having an end of a hyperbolic shape, making the discharge electrode emit thermal electrons a number of times, and examining changes in arc discharge voltage. An increase of the discharge voltage indicates that the electrode end is worn to cause deterioration of discharge performance. As will be understood from FIG. 3, in a case of the ThO₂-containing W, the discharge performance is deteriorated by 100 times of discharge, while, in a case of the La₂O₃-containing W, the discharge voltage is stable up to 600 times of discharge, that is, stable thermal electron emission is achieved. When a temperature of the electrode end during arc discharge was measured by a radiation thermometer, the electrode of the ThO₂-containing W had the temperature of 3700° C., while the electrode of the La₂O₃-containing W had the temperature of 3000° C. It is understood that such a temperature difference is generated due to a profile of electric discharge generated and a difference in thermal conductivity. For the La₂O₃-containing W illustrated in the figure, W with La₂O₃ introduced by 3% by volume ratio is used as the filament.

Next, an effect of forming a film of LaB₆ on the surface will be described. It is known that a LaB₆ crystal is a chemically-stable low-work-function material (work function of about 2.7 eV) and provides a high thermal electron emission current density. However, a technique of forming a high-quality LaB₆ thin film has not been established as yet.

On the other hand, the present inventors have found that, by controlling a normalized ion irradiation amount (the number of incident Ar ions with respect to LaB₆ emitted onto a surface of a LaB₆ film while the film is formed (expressed by Ar⁺/LaB₆)) and an ion irradiation energy in a newly developed rotary magnet sputtering apparatus which is capable of preventing occurrence of plasma damage (which will be described hereinbelow), a thin film excellent in crystallinity and having a work function of 2.8 eV can be formed.

In the present embodiment, on a surface of the filament of the La₂O₃-containing W, a LaB₆ thin film having a film thickness of 100 nm is formed using the rotary magnet sputtering apparatus. By using the filament, a stable electron emission current is obtained at a low temperature of about 1400° C. and a magnetron having a long service life is achieved.

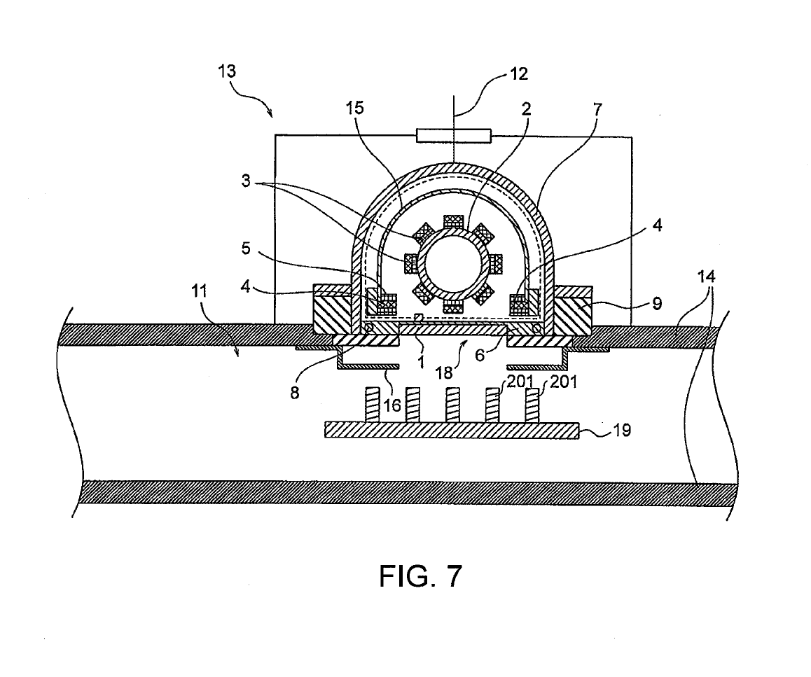

FIG. 7 is a view showing an example of the rotary magnet sputtering apparatus used in the present invention. The rotary magnet sputtering apparatus illustrated in FIG. 7 has a target 1, a columnar rotary shaft 2 having a polygonal shape (for example, a regular hexadecagonal shape), a rotary magnet group 3 including a plurality of spiral plate magnet groups spirally attached to a surface of the columnar rotary shaft 2, a fixed outer peripheral plate magnet 4 arranged at the outer periphery of the rotary magnet group 3 so as to surround the rotary magnet group 3, and an outer peripheral paramagnet 5 disposed opposite to the target 1 with respect to the fixed outer peripheral plate magnet 4. Furthermore, to the target 1, a backing plate 6 is adhered. The columnar rotary shaft 2 and the spiral plate magnet group 3, except those parts which are on a side faced to the target 1, are covered by a paramagnet 15. Furthermore, the paramagnet 15 is covered by a housing 7.

As seen from the target 1, the fixed outer peripheral plate magnet 4 has a structure surrounding the rotary magnet group 3 comprising the spiral plate magnet groups and, herein, is magnetized so as to have an S pole on the side faced to the target 2. Each of the fixed outer peripheral plate magnet 4 and plate magnets of the spiral plate magnet groups is formed of a Nd—Fe—B sintered magnet.

Further, in an illustrated space 11 in a processing room, a plasma shielding member 16 and a cathode body manufacturing jig 19 are placed. The space is reduced in pressure and a plasma gas is introduced therein.

The plasma shielding member 16 illustrated in the figure extends in an axial direction of the columnar rotary shaft 2 and defines a slit 18 which allows the target 1 to be open to the cathode body manufacturing jig 19. A region which is not shielded by the plasma shielding member 16 (i.e., a region open to the target 1 by the slit 18) is a region where a magnetic field intensity is high so that plasma having a high density and a low electron temperature is generated and neither charge-up damage nor ion irradiation damage is caused in a cathode body member placed in the cathode body manufacturing jig 19, and a region where a film-forming rate is high. By shielding the other region than the above-mentioned region by the plasma shielding member 16, it is possible to perform damage-free film formation without substantially reducing a film-forming rate.

The backing plate 6 is provided with a refrigerant path 8 for a refrigerant to pass therethrough. Between a housing 7 and an outer wall 14 forming a processing room, an insulating material 9 is arranged. A feeder line 12 connected to the housing 7 is extracted to the outside via a cover 13. The feeder line 12 is connected to a DC power source, a RF power source, and a matching box (not shown in the figure).

With this structure, a plasma excitation power is supplied from the DC power source and the RF power source to the backing plate 6 and the target 1 via the matching box, the feeder line 12, and the housing so that plasma is excited on a surface of the target. Although plasma excitation is possible only by a DC power or only by a RF power, it is desirable to apply both powers in view of film quality controllability and film-forming rate controllability. In general, a frequency of the RF power is selected from a range between several 100 kHz and several 100 MHz. In terms of achieving a high density and a low electron temperature of plasma, a high frequency is desirable. In the present embodiment, a frequency of 13.56 MHz is used.

As shown in FIG. 7, a plurality of filaments 201 which form the cathode body are fixed to the cathode body manufacturing jig 19 placed in the space 11 in the processing room.

As a film forming condition of the LaB₆ film by sputtering, it is preferable that a surface of an electrode material is first cleaned by plasma before film formation. For example, it is appropriate to use Ar plasma at 90 mTorr (12 Pa) and RF300 W. When a pressure of a chamber during sputtering is around 20 mTorr (2.7 Pa) (an electron temperature of about 1.9 eV and an ion irradiation energy of about 10 eV in case of Ar plasma), a specific resistance becomes the minimum (about 200μΩcm before annealing). At this time, a film forming rate is 90 nm/minute. If the pressure is set to 10 mTorr (1.3 Pa), the film forming rate is further increased to 100 nm/minute or more and the specific resistance is only slightly increased. Therefore, the pressure is preferably 5 to 35 mTorr (0.67 Pa to 4.7 Pa). If a substrate temperature (stage temperature) is increased, the specific resistance is further decreased. When Ar pressure is 20 mTorr (2.7 Pa) and the substrate temperature is 300° C., the specific resistance is about 175μΩcm. Furthermore, by performing annealing after film formation, the specific resistance is further decreased. By annealing at a temperature of 800° C. in high-purity Ar, the specific resistance is decreased to about 100μΩcm. Preferably, an annealing temperature is 400° C. to 1000° C. An annealing time must be 30 minutes or more. For example, 3 hours or less is sufficient. As an annealing atmosphere, an inactive gas is appropriate.

Next, for the purpose of examining an optimum condition of LaB₆ film formation by sputtering, the following experiment was performed. A SiO₂ film was formed on a Si substrate by thermal oxidation to a thickness of 90 nm and a LaB₆ film was formed thereon to a thickness of 80 nm using the rotary magnet sputtering apparatus in FIG. 7. In this process, the following parameters were changed and an orientation (XRD measurement) and a resistivity were measured.
film forming pressure (5 mTorr to 90 mTorr, 0.67 Pa to 12 Pa in SI unit)
ion irradiation energy (9 eV to 80 eV)
normalized ion irradiation amount (Ar⁺/LaB₆=about 1 to 20)

As a result of the XRD measurement, it was found that, in the LaB₆ film formed by sputtering by the rotary magnet sputtering apparatus, (210), (200), and (110) crystal planes have an extremely low intensity, while a (100) crystal plane has an extremely high intensity and an excellent film quality. As compared to conventional film formation by sputtering in which a (100) plane has a low intensity, this is one of characteristics of the present invention.

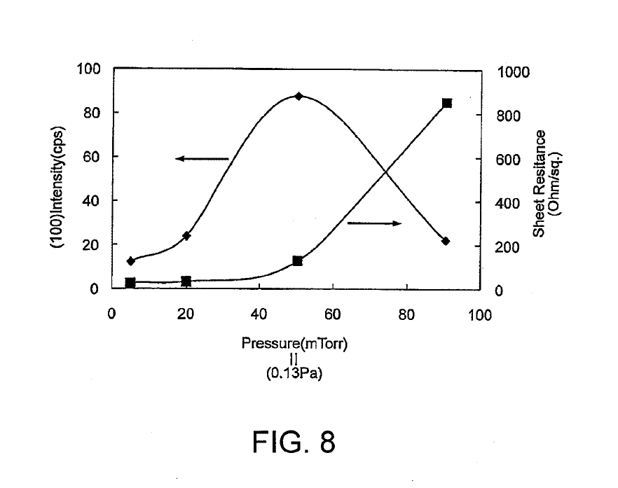

FIG. 8 shows pressure dependencies of a peak intensity and a sheet resistance of such a (100) plane in the LaB₆ film according to the present invention. These data are obtained when plasma is generated by using an Ar gas and applying a DC power of 900 W. As shown in FIG. 8, it is understood that, in DC discharge using Ar at about 20 mTorr (2.7 Pa), a sheet resistance is extremely low (about 200μΩcm in specific resistance value) but a (100) peak intensity is low and crystallinity is low. On the other hand, in DC discharge with Ar at 50 mTorr (6.7 Pa), a LaB₆ film having substantially (100) orientation is obtained but a resistance becomes high (about 1000μΩcm in specific resistance value).

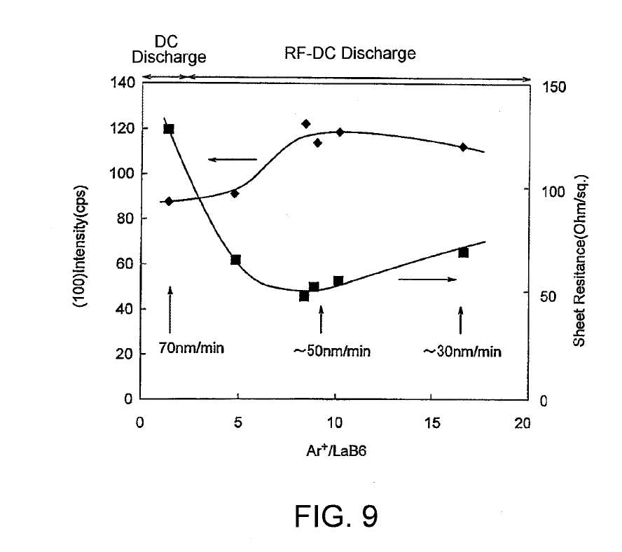

On the other hand, FIG. 9 shows changes of a (100) peak intensity and a sheet resistance when the normalized ion irradiation amount is changed from about 1 to about 20.

Referring to FIG. 9, it is found that, when ion irradiation energy is suppressed to about 10 eV or less and a normalized ion irradiation amount is increased to about 5 to 17, a resistance is decreased (300 to 400μΩcm in specific resistance value) and crystallinity is also improved. The results in FIG. 9 are obtained when an Ar pressure is 50 mTorr (6.7 Pa), ion irradiation energy in all cases is nearly 9.0 eV, and target power density in all cases is nearly 2 W/cm². In FIG. 9, DC discharge is performed at 900 W and, at that time, a normalized ion irradiation amount (Ar⁺/LaB₆) is 1.3. On the other hand, in RF-DC discharge, a RF frequency is 13.56 MHz and a RF power is 600 W.

When the normalized ion irradiation amount (Ar⁺/LaB₆) is 8.3, 10.1, and 16.5, DC voltage is −270V, −240V, and −180V, respectively.

### Second Embodiment

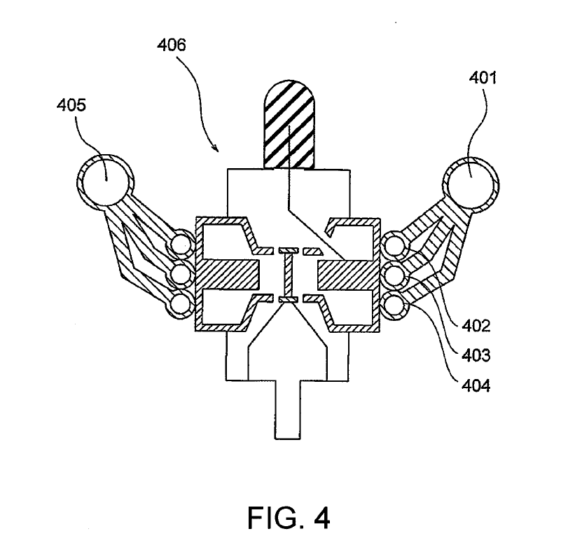

A second Embodiment of the present invention will be described using FIG. 4. 406 represents a 30 kW-output magnetron, 401, an inlet tube for introducing, to the magnetron, cooling water which is for cooling an anode of the magnetron, and 404 an outlet tube for the cooling water. 402, 403, and 403 represent first, second, and third cooling tubes, respectively, and are connected in parallel between the inlet tube 401 and the outlet tube 404 so as to be wound around the anode. The cooling water is introduced by a pump which is not shown in the figure.

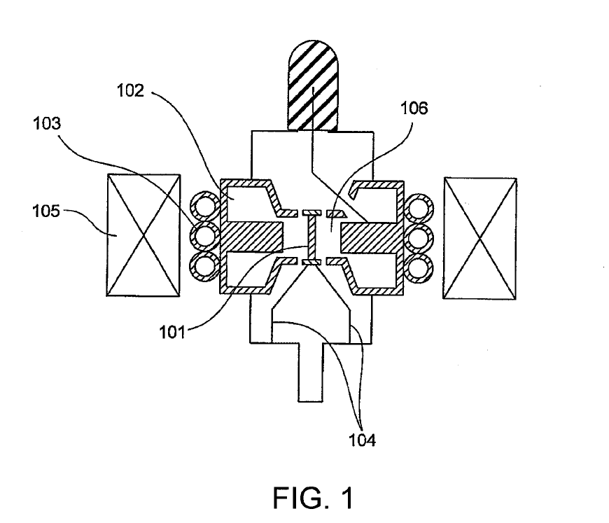

In a conventional technique, as shown in FIG. 1, one tube having an inner diameter of, for example, 6 mm is simply wound around an anode a plurality of times.

Herein, in a case of the 30 kW-output magnetron, it is required to remove a heat flow of about 6 kW by water. If temperatures of water at an inlet and at an outlet are 25° C. and 60° C., respectively, cooling water in an amount of 2.5 L/minute is required. When the above-mentioned amount of cooling water is introduced by one tube having an inner diameter of 6 mm, a water flow rate in the tube is 1.5 m/second and the Reynolds number is about 8000. The Reynolds number is a dimensionless number representing a level of a turbulent flow. If the Reynolds number is about 1000 or more, the flow is a turbulent flow, while, if the Reynolds number is less than that, the flow is a laminar flow. In the laminar flow having the Reynolds number of 1000 or less, a pressure loss of water is low and a pump load is low but a cooling efficiency is low.

On the other hand, in a case of the turbulent flow, the cooling efficiency is increased. When the Reynolds number is about 5000 or more, the cooling efficiency is substantially saturated. However, the pump load is increased with an increase of the Reynolds number so that a pump power is inevitably increased. In conclusion, when the Reynolds number is within a range of about 1000 to 5000, desirably about 2000 to 3000, the cooling efficiency is excellent and the pump load is low.

In the present embodiment, three tubes each having an inner diameter of 6 mm are connected in parallel to each of the inlet tube 401 and the outlet tube 405. Therefore, in each of the tubes, a water flow amount is one third. As a result, a flow rate is also one third and the Reynolds number is about 3000. Each of the inlet tube 401 and the outlet tube 405 has an inner diameter of 55 mm and the Reynolds number thereat is about 900 so that a laminar flow could be achieved. Thus, anode cooling with a low pump load and an excellent cooling efficiency could be achieved.

### Third Embodiment

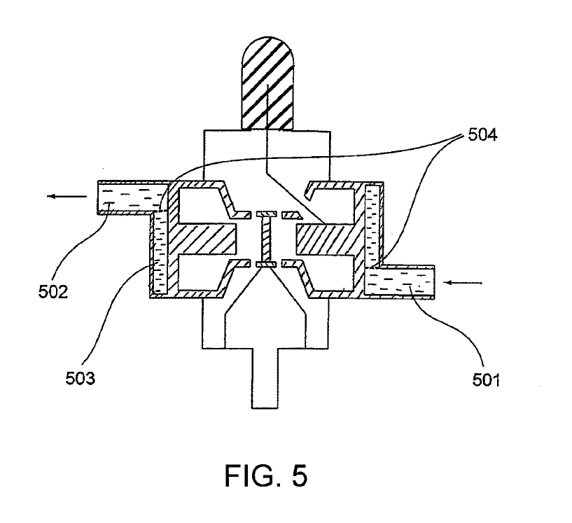

A third embodiment of the present invention will be described using FIG. 5. 501 and 502 represent an inlet tube for introducing, to a magnetron, cooling water for anode cooling of the magnetron and an outlet tube for the cooling water, respectively. 503 represents a cylindrical jacket outside the anode. By flowing the cooling water in the jacket, the anode is cooled. 504 represents baffle plates formed at an inlet and an outlet of the jacket for the purpose of achieving uniform flow rate distribution in the jacket. Each of the tubes 501 and 502 has an inner diameter of 55 mm and the Reynolds number is about 900. On the other hand, within the jacket, a distance between flow passages is set so that the Reynolds number is 2500. With this structure, anode cooling with a low pump load and an excellent cooling efficiency could be achieved.

### Fourth Embodiment

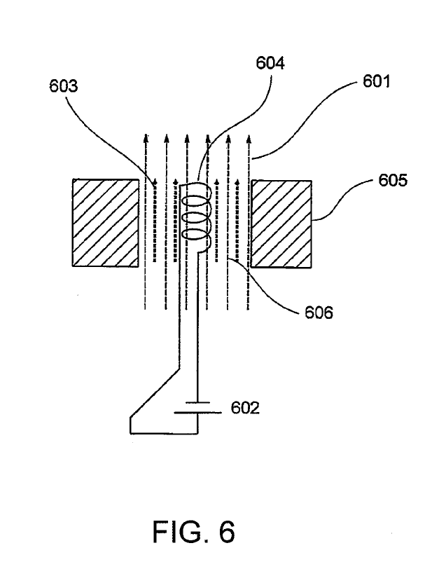

A fourth embodiment of the present invention will be described using FIG. 6. 601 represents a DC magnetic field applied from the outside, 602, a DC power source for supplying a filament current for heating a filament, 604, the filament, and 603, a DC magnetic field generated by the filament current. 605 represents an anode vain and 606 represents an interaction space. In a conventional technique, the filament is heated by supplying an AC current to the filament. However, since the filament current is high, an AC magnetic field is generated so that a magnetic field in the interaction space is changed. Therefore, fluctuation is caused to occur in an orbit of circulating electrons. This causes occurrence of ripples in magnetron output power and in frequency. For example, in a case where a filament diameter is 5 mm, the number of turns is 10, and a filament current is 100 A, a magnetic field intensity generated by the filament current in the interaction space separated from the filament by 1 mm is 91 gauss which is a nonnegligible value with respect to an external magnetic field.

In the present embodiment, a DC power source is used so that magnetic field variation is not caused to occur. Further, by keeping a direction of a magnetic field generated by the filament same as a direction of the external magnetic field, a decrease of a magnetic field intensity is also prevented. Thus, stable magnetron oscillation without ripples in an output power and in an oscillation frequency has been achieved.

### INDUSTRIAL APPLICABILITY

The present invention is applicable not only to a high-power industrial magnetron, i.e. a large-sized magnetron having an oscillation frequency of 915 MHz but also to a magnetron having an oscillation frequency of 2.45 GHz for domestic use.

1. A magnetron comprising a cathode body which includes, as a base material, a high-melting-point metal containing an electron emission material, and rare-earth boride with which a surface of the base material is coated.

2. The magnetron as claimed in claim 1, wherein the electron emission material is La₂O₃ and the rare earth boride is LaB₆.

3. A magnetron including, as a cathode body, an electrode comprising an electrode member containing tungsten or molybdenum as a main component and La₂O₃, and a film of rare-earth boride formed by sputtering on a surface of the electrode member.

4. The magnetron as claimed in claim 3, wherein the rare-earth boride includes at least one boride selected from a group consisting of LaB₄, LaB₆, YbB₆, GaB₆, and CeB₆.

5. The magnetron as claimed in any one of claims 1 to 4, wherein the cathode body contains 4 to 6% La₂O₃ by volume ratio.

6. A method of manufacturing a magnetron cathode body, comprising forming a LaB₆ film by sputtering using a plasma sputtering apparatus on a surface of a cathode body containing tungsten or molybdenum as a main component.

7. The method of manufacturing a magnetron cathode body as claimed in claim 6, comprising the step of annealing, in an inactive gas atmosphere, the LaB₆ film formed by sputtering.

8. The method of manufacturing a magnetron cathode body as claimed in claim 7, wherein an annealing temperature is between 400° C. and 1000° C. in the annealing step.

9. The method of manufacturing a magnetron cathode body as claimed in claim 6 or 7, wherein the LaB₆ film is formed by sputtering by RF-DC coupled discharge with a normalized ion irradiation amount of 5 to 17.

10. The magnetron as claimed in claim 1, wherein a plurality of tubes for cooling water to flow therethrough are brought into contact with an anode in parallel to cool the anode.

11. The magnetron as claimed in claim 1, comprising a cylindrical jacket arranged outside of the anode and supplied with cooling water to flow therethrough so as to cool the anode.

12. The magnetron as claimed in claim 10 or 11, wherein, at a part of a flow path for the cooling water to pass therethrough, which part is brought into contact with the anode, the Reynolds number of the cooling water passing therethrough is set within a range between 1000 and 5000.

13. The magnetron as claimed in claim 12, wherein, in a cooling water tube for supplying the cooling water to the magnetron, the Reynolds number of the cooling water passing therethrough is set to 1000 or less.

14. The magnetron as claimed in claim 1, wherein, in order to emit a thermal electron by heating the cathode body, the cathode body is heated by supplying a DC current.

15. A cathode body comprising, as a base material, a high-melting-point metal containing an electron emission material, and a thin film of rare-earth boride formed on a surface thereof, the electron emission material being La₂O₃, the rare-earth boride being LaB₆, the thin film formed of LaB₆ having a substantially (100) crystal plane and a specific resistance value of 400 μΩcm or less.
